(19) United States
(12) Patent Application Publication
(10) Pub. No.: US 2018/0171269 A1
(43) Pub. Date: Jun. 21, 2018

(54) LAUNDRY METHOD

(71) Applicant: NOVOZYMES A/S, Bagsvaerd (DK)

(72) Inventors: Christian Ausig Christensen, Hellerup (DK); Henriette Draborg, Frederikssund (DK); Keith Gibson, Bagsvaerd (DK); Mette Louise Dissing Overgaard, Copenhagen S (DK)

(73) Assignee: NOVOZYMES A/S, Bagsvaerd (DK)

(21) Appl. No.: 15/736,044

(22) PCT Filed: Aug. 31, 2016
(86) PCT No.: PCT/EP2016/070478

§ 371 Date: Dec. 13, 2017

(30) Foreign Application Priority Data
Sep. 1, 2015 (EP) 15183262.3

(51) Int. Cl. C11D 3/386

(52) U.S. Cl. CPC C11D 3/38627; C11D 3/38645; C11D 3/38636

(57) ABSTRACT

The present invention concerns the use of a cutinase for preventing built up and/or removal of fuzz and pills, a method for laundering a textile and a detergent composition.

### REFERENCE TO A SEQUENCE LISTING

This application contains a Sequence Listing in computer readable form, which is incorporated herein by reference.

### FIELD OF THE INVENTION

The present invention concerns the use of a cutinase for preventing build-up and/or removal of fuzz and pills, a method for laundering a textile and a detergent composition.

### BACKGROUND OF THE INVENTION

Wearing, washing and tumble drying of fabric and textile exposes the textile to mechanical stress which damages the textile and fabric by breaking the fibers in the fabric/textile and thereby causing the textile/fabric to be covered with fuzz and pills. This gives the fabric or textile a worn look.

Fuzz and pills on the surface of textile washed in industrial and institutional laundries has a negative influence on the textile lifetime and it also influences the profitability of the industrial laundry, since they often own and rent out the textile they are washing. A worn look from fuzz and pills makes it impossible to rent out the textile. Textile made from polyester fibers are used extensively for workwear, uniforms and other fabrics washed in industrial and institutional laundries, either as pure polyester fabrics or mixed with e.g. cotton. The result is stronger textiles with a longer lifetime, however even polyester fibers can break and cause fuzz and pills leading to scrapping of the textile.

### SUMMARY OF THE INVENTION

The present invention concerns the use of a cutinase for preventing build-up and/or removal of fuzz and pills from a textile by exposing the textile to the enzyme during a laundry process. The invention further concerns a method for laundering a textile comprising the steps of:

a. Contacting the textile with a wash liquor comprising a surfactant;

b. Optionally adding one or more detergent components to the wash liquor;

c. Completing at least one wash cycle; and

d. Optionally rinsing the textile with water,

wherein a cutinase should be present in the wash liquor or in the rinse water during at least one wash cycle or at least one rinse cycle. In addition is claimed a detergent composition a cutinase, a cellulase and a surfactant, wherein the cutinase has at least 70%, 75%, 85%, 90%, 95%, 96%, 97%, 98%, 99% or 100% identity to the amino acid sequence of SEQ ID NO: 1 and wherein the cellulase has has at least 70%, 75%, 85%, 90%, 95%, 96%, 97%, 98%, 99% or 100% identity to the amino acid sequence of SEQ ID NO: 2 or the cellulase has at least 70%, 75%, 85%, 90%, 95%, 96%, 97%, 98%, 99% or 100% identity to the amino acid sequence of SEQ ID NO: 3.

Definitions

“Anti-pilling: The term “anti-pilling” denotes removal of fuzz and pills from the textile surface and/or prevention of formation of fuzz and pills on the textile surface.”

“Detergent components”: The term “detergent components” is defined herein to mean the types of chemicals which can be used in detergent compositions. Examples of detergent components are alkalis, surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, optical brighteners, bactericides, fungicides, soil suspending agents, soil release polymers, anti-redeposition agents, enzyme inhibitors or stabilizers, enzyme activators, antioxidants and solubilizers.

Institutional: The term “institutional” is defined herein to mean On Premise Laundries (OPL) large enough to be running their washing process similar to an industrial laundry using automatic dosing of several partially formulated detergent compositions to their washing machine(s) as opposed to those small OPL's manually dosing a single fully formulated detergent composition similar to a household situation.

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well.

“Polyester” as used herein means a linear polymeric molecule containing in-chain ester groups which are derived from condensation of a diacid with a diol or from the polymerization of hydroxy acids. The present invention applies to both aliphatic and aromatic polyesters. Particularly preferred polyesters are aromatic polyester articles which are used to produce fiber and resin and that comprise a synthetically produced long chain polymer comprising at least 85%, preferably at least 90% and most preferably at least 95%, by weight of an ester of a substituted aromatic carboxylic acid, such as substituted terephthalic acid or parasubstituted hydroxybenzoate or a mixture thereof. Other useful polyester articles include those made of bulk polymer, yarns, fabrics, films, resins and powders. The principal polyesters in industrial usage include polyethylene terephthalate (PET), tetramethylene terephthalate (PTMT), polybutylene terphthalate (PBT), polytrimethylene terephthalate (PTT) and polyethylenenaphthalate (PEN), polycyclohexanedimethylene terephthalate (CHDMT), polyethylene-4-oxybenzoate, A-Tell, polyglycolide, PHBA and 2GN. However, PET is the most common linear polymer produced and accounts for a majority of the polyester applied in industry today.

The polyester textile used herein is meant to include fibers, yarns, fabrics and garments comprising polyester. The polyester yarn or fabric or garment is made from pure poly (ethylene terephthalate), or is made from blends of poly (ethylene terephthalate) fibers and any other materials conventionally used for making textile such as wool, cotton, viscose and silk.

In a preferred embodiment the polyester fabric is a fabric blend comprising more than 5% (w/w) of polyester, in particular more than 10%, more than 15%, more than 20%, more than 30%, more than 35%, more than 50%, more than 65%, more than 90%, or more than 95% of polyester. In an even preferred embodiment, such fabric blend is polyester/cotton blend fabric. In an even preferred embodiment, the process of the invention is applied to textile consisting essentially of polyester, i.e. pure polyester textile (100% polyester), such as pure PET textile.

Partially formulated: The term “partially formulated” is defined herein to mean a detergent composition that does not contain all of the required detergent and/or enzyme components to wash the textile/fabric. A partially formulated detergent composition may lack an enzyme composition or one or more alkalis, surfactants, builders or other detergent components which is required for the cleaning process to begin. A fully formulated detergent composition may be prepared in the wash cycle by adding two or more partially formulated detergent compositions to the wash cycle.

Wash cycle: The term “wash cycle” is defined herein as a washing operation wherein textiles are immersed in the wash liquor, mechanical action of some kind is applied to the textile in order to release stains and to facilitate flow of wash liquor in and out of the textile and finally the superfluous wash liquor is removed. After one or more wash cycles, the textile is generally rinsed and dried.

Wash liquor: The term “wash liquor” is defined herein as the solution or mixture of water and detergent components optionally including one ore more enzymes.

### DETAILED DESCRIPTION OF THE INVENTION

The inventor has surprisingly found that cutinases can be used for preventing build-up and/or removal of fuzz and pills from a textile by exposing the textile to the enzyme during a laundry process. The textile can be exposed to the cutinase during a wash cycle and/or during a rinse cycle in the laundry process. The washing may be carried out at a residential washing machine, at an industrial or an institutional laundry.

During the washing processes, abrasion and fiber damage result in formation of loose fibers or “fuzz” that can become entangled and form “pills.” Textiles with fuzz and pills often exhibit a worn appearance and the textile becomes less soft. This is off course undesirable for the consumer/end user.

Industrial and institutional laundries often wash textiles up to 50 times. So for industrial washing fuzzing and pilling is a huge problem, as the laundry may discard textiles due to worn look eventhough the textile is not worn down.

The invention further concerns a method for laundering a textile comprising the steps of:

a. Contacting the textile with a wash liquor comprising a surfactant;

b. Optionally adding one or more detergent components to the wash liquor;

c. Completing at least one wash cycle; and

d. Optionally rinsing the textile with water,
wherein a cutinase should be present in the wash liquor or in the rinse water during at least one wash cycle or at least one rinse cycle.

In order to prevent and remove built up of fuzz and pills the cutinase should be used for washing several times. The cutinase should be used for washing at least 5 times before an effect on fuzz and pills is seen. In one embodiment the laundry process is carried out at least 5 times. In one embodiment the laundry process is carried out at least 10 times, at least 15 times or at least 20 times.

When the textile is washed according to the inventive method, the method may comprise at least two wash cycles, wherein at least one wash cycle is a pre-wash cycle and at least one wash cycle is a main wash cycle. The cutinase may be present in the wash liquor during the pre-wash or during the main wash or the cutinase may be present during the pre-wash and the main wash. In one embodiment the cutinase may be present during the rinse cycle.

The method can be carried out at home with the consumer or at industrial or institutional laundries.

For industrial and institutional laundering large batch washing machines (washer extractors) or tunnel washing machines (continues batch washers) are used. They can be operated by a certified washer operator. The washer operator loads and unloads the washer (for a tunnel washer this is an automatized process), and decides which chemicals to add to the washing machine as well as the temperature, the number of wash cycles and their duration—typically by choosing one of several preprogrammed washing programs. The various detergent components used for the washing process are added separately or as partially formulated detergent compositions and therefore allows the operator to dose these components separately. Industrial and institutional washing processes are usually carried out in very harsh environment, where strong alkali, strong acids and strong bleach are used during the process. A wash process in a conventional Washer Extractor consists of several steps, including one or more prewash, wash and rinse steps. These steps are carried our consecutively. A conventional CBW consists of separate prewash, wash and rinse zones. Fresh water is introduced into the rinse zone of the machine and is passed cascade-fashion toward the mainwash zone while the laundry is transported in a countercurrent direction. These steps are carried out sequentially while the wash load is transported.

During industrial and institutional washing the addition of the strong alkalis (sodium hydroxide, potassium hydroxide, sodium metasilicate or sodium carbonate) and acids can be made several times during the washing process.

In one embodiment of the invention the pH of the wash liquor is in the range of 7 to 13. The pH of the wash liquor may be in the range of 8.5-13, in the range of 9.5-13, in the range of 10-13, in the range of 10.5-13, in the range of 11-13, in the range of 11.5-13, in the range of 12-13 or in the range of 12.5-13. The pH of the wash liquor is typically 1-4 pH units higher in industrial laundry than in residential laundry.

The temperature of the wash liquor may be in the range of 15 to 90° C.

In one embodiment of the invention the temperature may be in the range of 15° C.-60° C., such as about 15° C., about 20° C., about 25° C., about 30° C., about 35° C., about 40° C., about 45° C., about 50° C., about 55° C. or about 60° C.

In one embodiment the temperature may be in the range of 65° C.-90° C., such as about 65° C., about 70° C., about 75° C., about 80° C., about 85° C. or about 90° C.

In one embodiment the temperature of the wash liquor may be in the range of 40° C.-60° C., such as in the range of 45° C.-60° C. or in the range of 50° C.-60° C.

Cutinases are lipolytic enzymes classified as EC 3.1.1.74 according to Enzyme Nomenclature. Reference is made to the Recommendations of the Nomenclature Committee of the International Union of Biochemistry and Molecular Biology, Academic Press Inc., 1992.

For purposes of the present invention, cutinase activity is determined using oligomer Terephtalic acid-bis-2-benzoyloxy-ethylesther (BETEB) as substrate according to Assay I of the present patent application. BETEB is a by-product during the PET synthesis and is generally remained in the fabric or garment during textile manufacturing. BETEB is produced by e.g. condensation of terephthalic acid, benzoic acid and ethylene glycol, which has the same unit of benzoyloxy-ethylester as PET.

The enzyme in question qualifies as a cutinase for use according to the present invention if transparent zones are shown after testing.

Cutinases are known from various fungi, such as a filamentous fungal cutinase, e.g. native to a strain of Humicola or Fusarium or Magnaporthe or Pseudomonas, specifically H. insolens or F. solani pisi or Magnaporthe grisea or Pseudomonas mendocina, more specifically H. insolens strain DSM 1800 (U.S. Pat. No. 5,827,719), or F. solani pisi (WO 90/09446 FIG. 1; WO 94/14964 FIG. 1D, WO 94/03578 FIG. 1D, all hereby incorporated by reference) or Magnaporthe grisea (WO10/107560 SEQ ID NO: 1, hereby incorporated by reference) or Pseudomonas mendocina ATCC 53552 (U.S. Pat. No. 5,389,536, claim 1, hereby incorporated by reference).

SEQ ID NO: 1 is the amino acid sequence of the Humicola insolens cutinase (corresponding to the mature part of SEQ ID NO: 2 of U.S. Pat. No. 5,827,719). In some embodiments, the cutinase is variants comprising a substitution, deletion, and/or insertion of one or more (or several) amino acids of SEQ ID NO: 1. Preferably, the total number of amino acid substitutions, deletions and/or insertions of the SEQ ID NO: 1 is not more than 10, e.g., 1, 2, 3, 4, 5, 6, 7, 8 or 9. The Humicola insolens cutinase variants described in WO 2001/092502 are hereby incorporated by reference. The cutinase enzyme may also be a variant of a parent cutinase such as those described in WO 00/34450, hereby incorporated by reference.

In on embodiment the cutinase has at least 70%, 75%, 85%, 90%, 95%, 96%, 97%, 98%, 99% or 100% identity to the amino acid sequence of SEQ ID NO: 1.

The fungal cutinase may also be derived from other fungal strains such as a strain of Rhizoctonia, e.g. R. solani, or a strain of Alternaria, e.g. A. brassicicola (WO 94/03578).

In one embodiment of the present invention, the a polypeptide of the present invention may be added to a detergent composition in an amount corresponding to 0.001-200 mg of protein, such as 0.005-100 mg of protein, preferably 0.01-50 mg of protein, more preferably 0.05-20 mg of protein, even more preferably 0.1-10 mg of protein per liter of wash liquor.

The enzyme(s) of the detergent composition of the invention may be stabilized using conventional stabilizing agents, e.g. a polyol such as propylene glycol or glycerol, a sugar or sugar alcohol, lactic acid, boric acid, or a boric acid derivative, e.g. an aromatic borate ester, or a phenyl boronic acid derivative such as 4-formylphenyl boronic acid, and the composition may be formulated as described in, for example, WO92/19709 and WO92/19708.

A polypeptide of the present invention may also be incorporated in the detergent formulations disclosed in WO97/07202, which is hereby incorporated by reference.

The term “variant” means a polypeptide having cutinase activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position. The variants of the present invention have at least 70%, at least 75%, at least 80%, at least 85%, at least 90%, at least 95%, or at least 100% of the cutinase activity of the mature polypeptide of SEQ ID NO: 1

In describing the variants of the present invention, the nomenclature described below is adapted for ease of reference. The accepted IUPAC single letter or three letter amino acid abbreviation is employed.

Substitutions. For an amino acid substitution, the following nomenclature is used: Original amino acid, position, substituted amino acid. Accordingly, the substitution of threonine at position 226 with alanine is designated as “Thr226Ala” or “T226A”. Multiple mutations are separated by addition marks (“+”), e.g., “Gly205Arg+Ser411Phe” or “G205R+S411F”, representing substitutions at positions 205 and 411 of glycine (G) with arginine (R) and serine (S) with phenylalanine (F), respectively.

Deletions. For an amino acid deletion, the following nomenclature is used: Original amino acid, position, *. Accordingly, the deletion of glycine at position 195 is designated as “Gly195*” or “G195*”. Multiple deletions are separated by addition marks (“+”), e.g., “Gly195*+Ser411*” or “G195*+S411*”.

Different alterations. Where different alterations can be introduced at a position, the different alterations are separated by a comma, e.g., “Arg170Tyr,Glu” represents a substitution of arginine at position 170 with tyrosine or glutamic acid. Thus, “Tyr167Gly,Ala+Arg170Gly,Ala” designates the following variants: “Tyr167Gly+Arg170Gly”, “Tyr167Gly+Arg170Ala”, “Tyr167Ala+Arg170Gly”, and “Tyr167Ala+Arg170Ala”.

In one embodiment of the present invention the cutinase is a variant SEQ ID NO: 1, which variant comprises substitution of at least one amino acid residue corresponding to position A4, T29, A88, N91, A130, Q139, A161, T166, I169, L167, I178, R181, G182 or R189 of SEQ ID NO: 1.

In one embodiment the variant has the following alterations T29M+A161L+T166I+L167P+R181P+G182* of SEQ ID NO: 1.

The variants can be prepared using any mutagenesis procedure known in the art, such as site-directed mutagenesis, synthetic gene construction, semi-synthetic gene construction, random mutagenesis, shuffling, etc.

Site-directed mutagenesis is a technique in which one or more (e.g., several) mutations are introduced at one or more defined sites in a polynucleotide encoding the parent.

Site-directed mutagenesis can be accomplished in vitro by PCR involving the use of oligonucleotide primers containing the desired mutation. Site-directed mutagenesis can also be performed in vitro by cassette mutagenesis involving the cleavage by a restriction enzyme at a site in the plasmid comprising a polynucleotide encoding the parent and subsequent ligation of an oligonucleotide containing the mutation in the polynucleotide. Usually the restriction enzyme that digests the plasmid and the oligonucleotide is the same, permitting sticky ends of the plasmid and the insert to ligate to one another. See, e.g., Scherer and Davis, 1979, Proc. Natl. Acad. Sci. USA 76: 4949-4955; and Barton et al., 1990, Nucleic Acids Res. 18: 7349-4966.

Site-directed mutagenesis can also be accomplished in vivo by methods known in the art. See, e.g., US2004/0171154; Storici et al., 2001, Nature Biotechnol. 19: 773-776; Kren et al., 1998, Nat. Med. 4: 285-290; and Calissano and Macino, 1996, Fungal Genet. Newslett. 43: 15-16.

Any site-directed mutagenesis procedure can be used in the present invention. There are many commercial kits available that can be used to prepare variants.

Synthetic gene construction entails in vitro synthesis of a designed polynucleotide molecule to encode a polypeptide of interest. Gene synthesis can be performed utilizing a number of techniques, such as the multiplex microchip-based technology described by Tian et al. (2004, Nature 432: 1050-1054) and similar technologies wherein oligonucleotides are synthesized and assembled upon photo-programmable microfluidic chips.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO95/17413; or WO95/22625. Other methods that can be used include error-prone PCR, phage display (e.g., Lowman et al., 1991, Biochemistry 30: 10832-10837; U.S. Pat. No. 5,223,409; WO92/06204) and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

Semi-synthetic gene construction is accomplished by combining aspects of synthetic gene construction, and/or site-directed mutagenesis, and/or random mutagenesis, and/or shuffling. Semi-synthetic construction is typified by a process utilizing polynucleotide fragments that are synthesized, in combination with PCR techniques. Defined regions of genes may thus be synthesized de novo, while other regions may be amplified using site-specific mutagenic primers, while yet other regions may be subjected to error-prone PCR or non-error prone PCR amplification.

Polynucleotide subsequences may then be shuffled.

The relatedness between two amino acid sequences or between two nucleotide sequences is described by the parameter “sequence identity”.

For purposes of the present invention, the degree of sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the −nobrief option) is used as the percent identity and is calculated as follows:

(Identical Residues×100)/(Length of Alignment−Total Number of Gaps in Alignment)

For purposes of the present invention, the degree of sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 3.0.0 or later. The optional parameters used are gap open penalty of 10, gap extension penalty of 0.5, and the EDNAFULL (EMBOSS version of NCBI NUC4.4) substitution matrix. The output of Needle labeled “longest identity” (obtained using the −nobrief option) is used as the percent identity and is calculated as follows:

(Identical Deoxyribonucleotides×100)/(Length of Alignment−Total Number of Gaps in Alignment)

In addition to the cutinase further enzymes can be used for washing. In one embodiment of the invention the wash liquor further comprise at least one enzyme selected from the group consisting of hemicellulases, peroxidases, proteases, cellulases, xylanases, lipases, phospholipases, esterases, pectinases, mannanases, lyase, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, chlorophyllases, amylases, perhydrolases, peroxidases and xanthanase.

The selection of further enzymes are specified below.

The cutinase has an effect on fuzzing and pilling on textiles comprising polyester. In one embodiment the textile consists of polyester. In one embodiment the textile further comprises cotton. Fuzzing and pilling is also a recognized problem for cotton textiles. Fuzzing and pilling originating form cotton fibres can be prevented and/or removed with cellulases.

In one embodiment the textile is further exposed to a cellulase during the laundry process. The cellulase may be added to the wash liquor during a wash cycle. The cellulase may be an endoglucanase.

In one embodiment the cellulase has has at least 70%, 75%, 85%, 90%, 95%, 96%, 97%, 98%, 99% or 100% identity to the amino acid sequence of SEQ ID NO: 2.

In one embodiment the cellulase has at least 70%, 75%, 85%, 90%, 95%, 96%, 97%, 98%, 99% or 100% identity to the amino acid sequence of SEQ ID NO: 3. Commercially available cellulases preventing and/or removing fuzz and pills are sold under the tradenames Carezyme™ (supplied by Novozymes), Carezyme Premium™ (supplied by Novozymes), Celluclean Classic™ (supplied by Novozymes), Biotouch® (AB Enzymes) and Revitalenz® (Dupont).

The inventor has found that by using a cutinase for preventing/removing fuzz and pills at least 25% of the pills are removed from the surface of the textile compared to a similar wash without a cutinase being present in the wash liquor. In one embodiment of the invention at least 30%, at least 40%, at least 50%, at least 60%, at least 70%, at least 80% or at least 90% of the pills are removed from the surface surface compared to a similar wash without a cutinase being present in the wash liquor.

The invention further concerns a detergent composition comprising a cutinase, a cellulase and a surfactant, wherein the cutinase has at least 70%, 75%, 85%, 90%, 95%, 96%, 97%, 98%, 99% or 100% identity to the amino acid sequence of SEQ ID NO: 1 and wherein the cellulase has has at least 70%, 75%, 85%, 90%, 95%, 96%, 97%, 98%, 99% or 100% identity to the amino acid sequence of SEQ ID NO: 2 or the cellulase has at least 70%, 75%, 85%, 90%, 95%, 96%, 97%, 98%, 99% or 100% identity to the amino acid sequence of SEQ ID NO: 3.

The surfactant may ba an anionic surfactant and can be selected from the anionic surfactants mentioned below.

The detergent composition may further comprise one or more additional detergent components. The choice of additional components is within the skill of the artisan and includes conventional ingredients, including the exemplary non-limiting components set forth below.

Surfactants

The detergent composition may comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant(s) is typically present at a level of from about 0.1% to 60% by weight, such as about 1% to about 40%, or about 3% to about 20%, or about 3% to about 10%. The surfactant(s) is chosen based on the desired cleaning application, and may include any conventional surfactant(s) known in the art.

When included therein the detergent will usually contain from about 1% to about 40% by weight of an anionic surfactant, such as from about 5% to about 30%, including from about 5% to about 15%, or from about 15% to about 20%, or from about 20% to about 25% of an anionic surfactant. Non-limiting examples of anionic surfactants include sulfates and sulfonates, in particular, linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), and combinations thereof.

When included therein the detergent will usually contain from about from about 1% to about 40% by weigh of a cationic surfactant, for example from about 0.5% to about 30%, in particular from about 1% to about 20%, from about 3% to about 10%, such as from about 3% to about 5%, from about 8% to about 12% or from about 10% to about 12%. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

When included therein the detergent will usually contain from about 0.2% to about 40% by weight of a nonionic surfactant, for example from about 0.5% to about 30%, in particular from about 1% to about 20%, from about 3% to about 10%, such as from about 3% to about 5%, from about 8% to about 12%, or from about 10% to about 12%. Non-limiting examples of nonionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

When included therein the detergent will usually contain from about 0%o about 20% by weight of a semipolar surfactant. Non-limiting examples of semipolar surfactants include amine oxides (AO) such as alkyldimethylamineoxide, N-(coco alkyl)-N,N-dimethylamine oxide and N-(tallow-alkyl)-N,N-bis(2-hydroxyethyl)amine oxide, and combinations thereof.

When included therein the detergent will usually contain from about 0% to about 20% by weight of a zwitterionic surfactant. Non-limiting examples of zwitterionic surfactants include betaines such as alkyldimethylbetaines, sulfobetaines, and combinations thereof.

Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants); however the molecular structure of hydrotropes generally do not favor spontaneous self-aggregation, see e.g. review by Hodgdon and Kaler (2007), Current Opinion in Colloid & Interface Science 12: 121-128. Hydrotropes do not display a critical concentration above which self-aggregation occurs as found for surfactants and lipids forming miceller, lamellar or other well defined meso-phases. Instead, many hydrotropes show a continuous-type aggregation process where the sizes of aggregates grow as concentration increases. However, many hydrotropes alter the phase behavior, stability, and colloidal properties of systems containing substances of polar and non-polar character, including mixtures of water, oil, surfactants, and polymers. Hydrotropes are classically used across industries from pharma, personal care, food, to technical applications. Use of hydrotropes in detergent compositions allow for example more concentrated formulations of surfactants (as in the process of compacting liquid detergents by removing water) without inducing undesired phenomena such as phase separation or high viscosity.

The detergent may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

Builders and Co-Builders

The detergent composition may contain about 0-65% by weight, such as about 5% to about 50% of a detergent builder or co-builder, or a mixture thereof. In a dish wash detergent, the level of builder is typically 40-65%, particularly 50-65%. The builder and/or co-builder may particularly be a chelating agent that forms water-soluble complexes with Ca and Mg. Any builder and/or co-builder known in the art for use in laundry detergents may be utilized. Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The detergent composition may also contain 0-50% by weight, such as about 5% to about 30%, of a detergent co-builder. The detergent composition may include include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTMPA), diethylenetriaminepentakis(methylenephosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053

Bleaching Systems

The detergent may contain 0-30% by weight, such as about 1% to about 20%, of a bleaching system. Any bleaching system known in the art for use in laundry cleaning detergents may be utilized. Suitable bleaching system components include bleaching catalysts, photobleaches, bleach activators, sources of hydrogen peroxide such as sodium percarbonate, sodium perborates and hydrogen peroxide-urea (1:1), preformed peracids and mixtures thereof. Suitable preformed peracids include, but are not limited to, peroxycarboxylic acids and salts, diperoxydicarboxylic acids, perimidic acids and salts, peroxymonosulfuric acids and salts, for example, Oxone (R), and mixtures thereof. Non-limiting examples of bleaching systems include peroxide-based bleaching systems, which may comprise, for example, an inorganic salt, including alkali metal salts such as sodium salts of perborate (usually mono- or tetra-hydrate), percarbonate, persulfate, perphosphate, persilicate salts, in combination with a peracid-forming bleach activator. The term bleach activator is meant herein as a compound which reacts with hydrogen peroxide to form a peracid via perhydrolysis. The peracid thus formed constitutes the activated bleach. Suitable bleach activators to be used herein include those belonging to the class of esters, amides, imides or anhydrides. Suitable examples are tetraacetylethylenediamine (TAED), sodium 4-[(3,5,5-trimethylhexanoyl)oxy]benzene-1-sulfonate (ISONOBS), 4-(dodecanoyloxy)benzene-1-sulfonate (LOBS), 4-(decanoyloxy)benzene-1-sulfonate, 4-(decanoyloxy)benzoate (DOBS or DOBA), 4-(nonanoyloxy)benzene-1-sulfonate (NOBS), and/or those disclosed in WO98/17767. A particular family of bleach activators of interest was disclosed in EP624154 and particularly preferred in that family is acetyl triethyl citrate (ATC). ATC or a short chain triglyceride like triacetin has the advantage that it is environmentally friendly Furthermore acetyl triethyl citrate and triacetin have good hydrolytical stability in the product upon storage and are efficient bleach activators. Finally ATC is multifunctional, as the citrate released in the perhydrolysis reaction may function as a builder. Alternatively, the bleaching system may comprise peroxyacids of, for example, the amide, imide, or sulfone type. The bleaching system may also comprise peracids such as 6-(phthalimido)peroxyhexanoic acid (PAP). The bleaching system may also include a bleach catalyst. In some embodiments the bleach component may be an organic catalyst selected from the group consisting of organic catalysts having the following formulae:

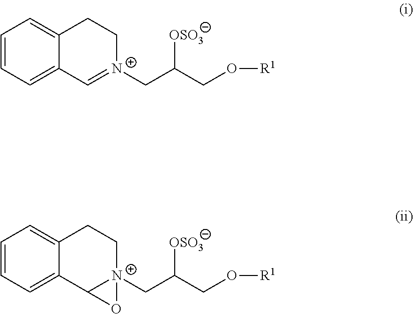

(iii) and mixtures thereof;

wherein each R¹ is independently a branched alkyl group containing from 9 to 24 carbons or linear alkyl group containing from 11 to 24 carbons, preferably each R¹ is independently a branched alkyl group containing from 9 to 18 carbons or linear alkyl group containing from 11 to 18 carbons, more preferably each R¹ is independently selected from the group consisting of 2-propylheptyl, 2-butyloctyl, 2-pentylnonyl, 2-hexyldecyl, dodecyl, tetradecyl, hexadecyl, octadecyl, isononyl, isodecyl, isotridecyl and isopentadecyl. Other exemplary bleaching systems are described, e.g. in WO2007/087258, WO2007/087244, WO2007/087259, EP1867708 (Vitamin K) and WO2007/087242. Suitable photobleaches may for example be sulfonated zinc or aluminium phthalocyanines.

Preferably the bleach component comprises a source of peracid in addition to bleach catalyst, particularly organic bleach catalyst. The source of peracid may be selected from (a) pre-formed peracid; (b) percarbonate, perborate or persulfate salt (hydrogen peroxide source) preferably in combination with a bleach activator; and (c) perhydrolase enzyme and an ester for forming peracid in situ in the presence of water in a textile or hard surface treatment step.

Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl)cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers, hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated.

Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and EP1876226 (hereby incorporated by reference). The detergent composition preferably comprises from about 0.00003 wt % to about 0.2 wt %, from about 0.00008 wt % to about 0.05 wt %, or even from about 0.0001 wt % to about 0.04 wt % fabric hueing agent. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO2007/087243.

Enzymes

The detergent additive as well as the detergent composition may comprise one or more [additional] enzymes such as a protease, lipase, cutinase, an amylase, carbohydrase, cellulase, pectinase, mannanase, arabinase, galactanase, xylanase, oxidase, e.g., a laccase, and/or peroxidase.

In general the properties of the selected enzyme(s) should be compatible with the selected detergent, (i.e., pH-optimum, compatibility with other enzymatic and non-enzymatic ingredients, etc.), and the enzyme(s) should be present in effective amounts.

Cellulases

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. No. 4,435,307, U.S. Pat. No. 5,648,263, U.S. Pat. No. 5,691,178, U.S. Pat. No. 5,776,757 and WO 89/09259.

Especially suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 and WO99/001544.

Other cellulases are endo-beta-1,4-glucanase enzyme having a sequence of at least 97% identity to the amino acid sequence of position 1 to position 773 of SEQ ID NO:2 of WO 2002/099091 or a family 44 xyloglucanase, which a xyloglucanase enzyme having a sequence of at least 60% identity to positions 40-559 of SEQ ID NO: 2 of WO 2001/062903.

Commercially available cellulases include Celluzyme™, and Carezyme™ (Novozymes A/S) Carezyme Premium™ (Novozymes A/S), Celluclean™ (Novozymes A/S), Celluclean Classic™ (Novozymes A/S), Cellusoft™ (Novozymes A/S), Whitezyme™ (Novozymes A/S), Clazinase™, and Puradax HA™ (Genencor International Inc.), and KAC-500(B)™ (Kao Corporation).

Mannanases

Suitable mannanases include those of bacterial or fungal origin. Chemically or genetically modified mutants are included. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes A/S).

Cellulase

Suitable cellulases include complete cellulases or mono-component endoglucanases of bacterial or fungal origin. Chemically or genetically modified mutants are included. The cellulase may for example be a mono-component or a mixture of mono-component endo-1,4-beta-glucanase often just termed endoglucanases. Suitable cellulases include a fungal cellulase from Humicola insolens (U.S. Pat. No. 4,435,307) or from Trichoderma, e.g. T. reesei or T. viride. Examples of cellulases are described in EP 0 495 257. Other suitable cellulases are from Thielavia e.g. Thielavia terrestris as described in WO 96/29397 or Fusarium oxysporum as described in WO 91/17244 or from Bacillus as described in, WO 02/099091 and JP 2000210081. Other examples are cellulase variants such as those described in WO 94/07998, EP 0 531 315, U.S. Pat. No. 5,457,046, U.S. Pat. No. 5,686,593, U.S. Pat. No. 5,763,254, WO 95/24471, WO 98/12307 Commercially available cellulases include Carezyme®, Celluzyme®, Celluclean®, Celluclast® and Endolase®; Renozyme®; Whitezyme® (Novozymes A/S) Puradax®, Puradax HA, Biotouch®, (AB Enzymes), Revitalenz® and Puradax EG (available from Genencor).

Peroxidases/Oxidases

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257. Commercially available peroxidases include Guardzyme™ (Novozymes A/S).

Proteases

Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from e.g. family M4 or other metalloprotease such as those from M5, M7 or M8 families.

The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Other useful proteases may be those described in WO92/175177, WO01/016285, WO02/026024 and WO02/016547. Examples of trypsin-like proteases are trypsin (e.g. of porcine or bovine origin) and the Fusarium protease described in WO89/06270, WO94/25583 and WO05/040372, and the chymotrypsin proteases derived from Cellumonas described in WO05/052161 and WO05/052146.

A further preferred protease is the alkaline protease from Bacillus lentus DSM 5483, as described for example in WO95/23221, and variants thereof which are described in WO92/21760, WO95/23221, EP1921147 and EP1921148.

Examples of metalloproteases are the neutral metalloprotease as described in WO07/044993 (Genencor Int.) such as those derived from Bacillus amyloliquefaciens.

Examples of useful proteases are the variants described in: WO92/19729, WO96/034946, WO98/20115, WO98/20116, WO99/011768, WO01/44452, WO03/006602, WO04/03186, WO04/041979, WO07/006305, WO11/036263, WO11/036264, especially the variants with substitutions in one or more of the following positions: 3, 4, 9, 15, 27, 36, 57, 68, 76, 87, 95, 96, 97, 98, 99, 100, 101, 102, 103, 104, 106, 118, 120, 123, 128, 129, 130, 160, 167, 170, 194, 195, 199, 205, 206, 217, 218, 222, 224, 232, 235, 236, 245, 248, 252 and 274 using the BPN′ numbering. More preferred the subtilase variants may comprise the mutations: S3T, V4I, S9R, A15T, K27R, *36D, V68A, N76D, N87S,R, *97E, A98S, S99G,D,A, S99AD, S101G,M,R S103A, V104I,Y,N, S106A, G118V,R, H120D,N, N123S, S128L, P129Q, S130A, G160D, Y167A, R170S, A194P, G195E, V199M, V205I, L217D, N218D, M222S, A232V, K235L, Q236H, Q245R, N252K, T274A (using BPN′ numbering).

Suitable commercially available protease enzymes include those sold under the trade names Alcalase®, Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Blaze®, Neutrase®, Everlase® and Esperase® (Novozymes A/S), those sold under the tradename Maxatase®, Maxacal®, Maxapem®, Purafect®, Purafect Prime®, Purafect MA®, Purafect Ox®, Purafect OxP®, Puramax®, Properase®, FN2®, FN3®, FN4®, Excellase®, Eraser®, Opticlean® and Optimase® (Danisco/DuPont), Axapem™ (Gist-Brocases N.V.), BLAP (sequence shown in FIG. 29 of U.S. Pat. No. 5,352,604) and variants hereof (Henkel AG) and KAP (Bacillus alkalophilus subtilisin) from Kao.

Lipases and Cutinases:

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include include Lipolase™, Lipex™; Lipolex™ and Lipoclean™ (Novozymes A/S), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

Amylases:

Suitable amylases which can be used together with the cutinase may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other amylases which are suitable are hybrid alpha-amylase comprising residues 1-33 of the alpha-amylase derived from B. amyloliquefaciens shown in SEQ ID NO: 6 of WO 2006/066594 and residues 36-483 of the B. licheniformis alpha-amylase shown in SEQ ID NO: 4 of WO 2006/066594 or variants having 90% sequence identity thereof. Preferred variants of this hybrid alpha-amylase are those having a substitution, a deletion or an insertion in one of more of the following positions: G48, T49, G107, H156, A181, N190, M197, I201, A209 and Q264. Most preferred variants of the hybrid alpha-amylase comprising residues 1-33 of the alpha-amylase derived from B. amyloliquefaciens shown in SEQ ID NO: 6 of WO 2006/066594 and residues 36-483 of SEQ ID NO: 4 are those having the substitutions:

M197T;

H156Y+A181T+N190F+A209V+Q264S; or

G48A+T49I+G107A+H156Y+A181T+N190F+I201F+A209V+Q264S.

Further amylases which are suitable are amylases having SEQ ID NO: 6 in WO 99/019467 or variants thereof having 90% sequence identity to SEQ ID NO: 6. Preferred variants of SEQ ID NO: 6 are those having a substitution, a deletion or an insertion in one or more of the following positions: R181, G182, H183, G184, N195, I206, E212, E216 and K269. Particularly preferred amylases are those having deletion in positions R181 and G182, or positions H183 and G184.

Additional amylases which can be used are those having SEQ ID NO: 1, SEQ ID NO: 3, SEQ ID NO: 2 or SEQ ID NO: 7 of WO 96/023873 or variants thereof having 90% sequence identity to SEQ ID NO: 1, SEQ ID NO: 2, SEQ ID NO: 3 or SEQ ID NO: 7. Preferred variants of SEQ ID NO: 1, SEQ ID NO: 2, SEQ ID NO: 3 or SEQ ID NO: 7 are those having a substitution, a deletion or an insertion in one or more of the following positions: 140, 181, 182, 183, 184, 195, 206, 212, 243, 260, 269, 304 and 476, using SEQ ID 2 of WO 96/023873 for numbering. More preferred variants are those having a deletion in two positions selected from 181, 182, 183 and 184, such as 181 and 182, 182 and 183, or positions 183 and 184. Most preferred amylase variants of SEQ ID NO: 1, SEQ ID NO: 2 or SEQ ID NO: 7 are those having a deletion in positions 183 and 184 and a substitution in one or more of positions 140, 195, 206, 243, 260, 304 and 476.

Other amylases which can be used are amylases having SEQ ID NO: 2 of WO 08/153815, SEQ ID NO: 10 in WO 01/66712 or variants thereof having 90% sequence identity to SEQ ID NO: 2 of WO 08/153815 or 90% sequence identity to SEQ ID NO: 10 in WO 01/66712. Preferred variants of SEQ ID NO: 10 in WO 01/66712 are those having a substitution, a deletion or an insertion in one of more of the following positions: 176, 177, 178, 179, 190, 201, 207, 211 and 264.

Further suitable amylases are amylases having SEQ ID NO: 2 of WO 09/061380 or variants having 90% sequence identity to SEQ ID NO: 2 thereof. Preferred variants of SEQ ID NO: 2 are those having a truncation of the C-terminus and/or a substitution, a deletion or an insertion in one of more of the following positions: Q87, Q98, S125, N128, T131, T165, K178, R180, S181, T182, G183, M201, F202, N225, S243, N272, N282, Y305, R309, D319, Q320, Q359, K444 and G475. More preferred variants of SEQ ID NO: 2 are those having the substitution in one of more of the following positions: Q87E,R, Q98R, S125A, N128C, T131I, T165I, K178L, T182G, M201L, F202Y, N225E,R, N272E,R, S243Q,A,E,D, Y305R, R309A, Q320R, Q359E, K444E and G475K and/or deletion in position R180 and/or S181 or of T182 and/or G183. Most preferred amylase variants of SEQ ID NO: 2 are those having the substitutions:

N128C+K178L+T182G+Y305R+G475K;

N128C+K178L+T182G+F202Y+Y305R+D319T+G475K;

S125A+N128C+K178L+T182G+Y305R+G475K; or

S125A+N128C+T131I+T165I+K178L+T182G+Y305R+G475K wherein the variants are C-terminally truncated and optionally further comprises a substitution at position 243 and/or a deletion at position 180 and/or position 181.

Further suitable amylases are amylases having SEQ ID NO: 1 of WO13184577 or variants having 90% sequence identity to SEQ ID NO: 1 thereof. Preferred variants of SEQ ID NO: 1 are those having a substitution, a deletion or an insertion in one of more of the following positions: K176, R178, G179, T180, G181, E187, N192, M199, I203, S241, R458, T459, D460, G476 and G477. More preferred variants of SEQ ID NO: 1 are those having the substitution in one of more of the following positions: K176L, E187P, N192FYH, M199L, I203YF, S241QADN, R458N, T459S, D460T, G476K and G477K and/or deletion in position R178 and/or S179 or of T180 and/or G181. Most preferred amylase variants of SEQ ID NO: 1 are those having the substitutions:

E187P+I203Y+G476K

E187P+I203Y+R458N+T459S+D460T+G476K

wherein the variants optionally further comprises a substitution at position 241 and/or a deletion at position 178 and/or position 179.

Further suitable amylases are amylases having SEQ ID NO: 1 of WO10104675 or variants having 90% sequence identity to SEQ ID NO: 1 thereof. Preferred variants of SEQ ID NO: 1 are those having a substitution, a deletion or an insertion in one of more of the following positions: N21, D97, V128 K177, R179, S180, I181, G182, M200, L204, E242, G477 and G478. More preferred variants of SEQ ID NO: 1 are those having the substitution in one of more of the following positions: N21D, D97N, V128I K177L, M200L, L204YF, E242QA, G477K and G478K and/or deletion in position R179 and/or S180 or of I181 and/or G182. Most preferred amylase variants of SEQ ID NO: 1 are those having the substitutions:

N21D+D97N+V128I

wherein the variants optionally further comprises a substitution at position 200 and/or a deletion at position 180 and/or position 181.

Other suitable amylases are the alpha-amylase having SEQ ID NO: 12 in WO01/66712 or a variant having at least 90% sequence identity to SEQ ID NO: 12. Preferred amylase variants are those having a substitution, a deletion or an insertion in one of more of the following positions of SEQ ID NO: 12 in WO01/66712: R28, R118, N174; R181, G182, D183, G184, G186, W189, N195, M202, Y298, N299, K302, S303, N306, R310, N314; R320, H324, E345, Y396, R400, W439, R444, N445, K446, Q449, R458, N471, N484. Particular preferred amylases include variants having a deletion of D183 and G184 and having the substitutions R118K, N195F, R320K and R458K, and a variant additionally having substitutions in one or more position selected from the group: M9, G149, G182, G186, M202, T257, Y295, N299, M323, E345 and A339, most preferred a variant that additionally has substitutions in all these positions.

Other examples are amylase variants such as those described in WO2011/098531, WO2013/001078 and WO2013/001087.

Commercially available amylases are Duramyl™, Termamyl™, Fungamyl™, Stainzyme™, Stainzyme Plus™, Natalase™, Liquozyme X and BAN™ (from Novozymes A/S), and Rapidase™, Purastar™/Effectenz™, Powerase, Preferenz S1000, Preferenz S100 and Preferenz S110 (from Genencor International Inc./DuPont).

Peroxidases/Oxidases

A peroxidase according to the invention is a peroxidase enzyme comprised by the enzyme classification EC 1.11.1.7, as set out by the Nomenclature Committee of the International Union of Biochemistry and Molecular Biology (IUBMB), or any fragment derived therefrom, exhibiting peroxidase activity.

Suitable peroxidases include those of plant, bacterial or fungal origin. Chemically modified or protein engineered mutants are included. Examples of useful peroxidases include peroxidases from Coprinopsis, e.g., from C. cinerea (EP 179,486), and variants thereof as those described in WO 93/24618, WO 95/10602, and WO 98/15257.

A peroxidase according to the invention also include a haloperoxidase enzyme, such as chloroperoxidase, bromoperoxidase and compounds exhibiting chloroperoxidase or bromoperoxidase activity. Haloperoxidases are classified according to their specificity for halide ions. Chloroperoxidases (E.C. 1.11.1.10) catalyze formation of hypochlorite from chloride ions.

In an embodiment, the haloperoxidase of the invention is a chloroperoxidase. Preferably, the haloperoxidase is a vanadium haloperoxidase, i.e., a vanadate-containing haloperoxidase. In a preferred method of the present invention the vanadate-containing haloperoxidase is combined with a source of chloride ion.

Haloperoxidases have been isolated from many different fungi, in particular from the fungus group dematiaceous hyphomycetes, such as Caldariomyces, e.g., C. fumago, Alternaria, Curvularia, e.g., C. verruculosa and C. inaequalis, Drechslera, Ulocladium and Botrytis.

Haloperoxidases have also been isolated from bacteria such as Pseudomonas, e.g., P. pyrrocinia and Streptomyces, e.g., S. aureofaciens.

In an preferred embodiment, the haloperoxidase is derivable from Curvularia sp., in particular Curvularia verruculosa or Curvularia inaequalis, such as C. inaequalis CBS 102.42 as described in WO 95/27046; or C. verruculosa CBS 147.63 or C. verruculosa CBS 444.70 as described in WO 97/04102; or from Drechslera hartlebii as described in WO 01/79459, Dendryphiella salina as described in WO 01/79458, Phaeotrichoconis crotalarie as described in WO 01/79461, or Geniculosporium sp. as described in WO 01/79460.

An oxidase according to the invention include, in particular, any laccase enzyme comprised by the enzyme classification EC 1.10.3.2, or any fragment derived therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinopsis, e.g., C. cinerea, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radiata (WO 92/01046), or Coriolus, e.g., C. hirsutus (JP 2238885).

Suitable examples from bacteria include a laccase derivable from a strain of Bacillus.

A laccase derived from Coprinopsis or Myceliophthora is preferred; in particular a laccase derived from Coprinopsis cinerea, as disclosed in WO 97/08325; or from Myceliophthora thermophila, as disclosed in WO 95/33836.

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids, or slurries.

Non-dusting granulates may be produced, e.g. as disclosed in U.S. Pat. Nos. 4,106,991 and 4,661,452 and may optionally be coated by methods known in the art. Examples of waxy coating materials are polyethyleneglycol (PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

Adjunct Materials

Any detergent components known in the art for use in laundry detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well within the skill of the artisan.

Dispersants

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Fluorescent Whitening Agent

The detergent compositions of the present invention will preferably also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention. The most commonly used fluorescent whitening agents are those belonging to the classes of diaminostilbene-sulfonic acid derivatives, diarylpyrazoline derivatives and bisphenyl-distyryl derivatives. Examples of the diaminostilbene-sulfonic acid derivative type of fluorescent whitening agents include the sodium salts of: 4,4′-bis-(2-diethanolamino-4-anilino-s-triazin-6-ylamino) stilbene-2,2′-disulfonate, 4,4′-bis-(2,4-dianilino-s-triazin-6-ylamino) stilbene-2,2′-disulfonate, 4,4′-bis-(2-anilino-4-(N-methyl-N-2-hydroxy-ethylamino)-s-triazin-6-ylamino) stilbene-2,2′-disulfonate, 4,4′-bis-(4-phenyl-1,2,3-triazol-2-yl)stilbene-2,2′-disulfonate and sodium 5-(2H-naphtho[1,2-d][1,2,3]triazol-2-yl)-2-[(E)-2-phenylvinyl]benzenesulfonate. Preferred fluorescent whitening agents are Tinopal DMS and Tinopal CBS available from Ciba-Geigy AG, Basel, Switzerland. Tinopal DMS is the disodium salt of 4,4′-bis-(2-morpholino-4-anilino-s-triazin-6-ylamino) stilbene-2,2′-disulfonate. Tinopal CBS is the disodium salt of 2,2′-bis-(phenyl-styryl)-disulfonate. Also preferred are fluorescent whitening agents is the commercially available Parawhite KX, supplied by Paramount Minerals and Chemicals, Mumbai, India. Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalate based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose derivatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

Anti-Redeposition Agents

The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

Rheology Modifiers

The detergent compositions of the present invention may also include one or more rheology modifiers, structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water soluble film. The compartment for liquid components can be different in composition than compartments containing solids: US2009/0011970 A1.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent.

A liquid or gel detergent may be non-aqueous.

Laundry Soap Bars

The cutinase and a cellulase of the detergent composition may be added to laundry soap bars and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH₄⁺ and the organic anion may be for example formate, acetate, citrate or lactate such that the salt of a monovalent cation and an organic anion may be, for example, sodium formate.

The laundry soap bar may also contain complexing agents like EDTA and HEDP, perfumes and/or different type of fillers, surfactants e.g. anionic synthetic surfactants, builders, polymeric soil release agents, detergent chelators, stabilizing agents, fillers, dyes, colorants, dye transfer inhibitors, alkoxylated polycarbonates, suds suppressers, structurants, binders, leaching agents, bleaching activators, clay soil removal agents, anti-redeposition agents, polymeric dispersing agents, brighteners, fabric softeners, perfumes and/or other compounds known in the art.

The laundry soap bar may be processed in conventional laundry soap bar making equipment such as but not limited to: mixers, plodders, e.g a two stage vacuum plodder, extruders, cutters, logo-stampers, cooling tunnels and wrappers. The invention is not limited to preparing the laundry soap bars by any single method. The premix of the invention may be added to the soap at different stages of the process. For example, the premix containing a soap, blend of enzymes, optionally one or more additional enzymes, a protease inhibitor, and a salt of a monovalent cation and an organic anion may be prepared and and the mixture is then plodded. The blend of enzymes and optional additional enzymes may be added at the same time as the protease inhibitor for example in liquid form. Besides the mixing step and the plodding step, the process may further comprise the steps of milling, extruding, cutting, stamping, cooling and/or wrapping.

Formulation of Enzyme in Co-Granule

The enzyme use in the invention may be formulated as a granule for example as a co-granule that combines one or more enzymes. Each enzyme will then be present in more granules securing a more uniform distribution of enzymes in the detergent. This also reduces the physical segregation of different enzymes due to different particle sizes. Methods for producing multi-enzyme co-granulates for the detergent industry are disclosed in the IP.com disclosure IPCOM000200739D.

Another example of formulation of enzymes by the use of co-granulates are disclosed in WO 2013/188331, which relates to a detergent composition comprising (a) a multi-enzyme co-granule; (b) less than 10 wt zeolite (anhydrous basis); and (c) less than 10 wt phosphate salt (anhydrous basis), wherein said enzyme co-granule comprises from 10 to 98 wt % moisture sink component and the composition additionally comprises from 20 to 80 wt % detergent moisture sink component.

WO 2013/188331 also relates to a method of treating and/or cleaning a surface, preferably a fabric surface comprising the steps of (i) contacting said surface with the detergent composition as claimed and described herein in an aqueous wash liquor, (ii) rinsing and/or drying the surface.

The multi-enzyme co-granule may comprise an enzyme of the invention and (a) one or more enzymes selected from the group consisting of first-wash lipases, cleaning cellulases, xyloglucanases, perhydrolases, peroxidases, lipoxygenases, laccases and mixtures thereof; and (b) one or more enzymes selected from the group consisting of hemicellulases, proteases, care cellulases, cellobiose dehydrogenases, xylanases, phospho lipases, esterases, cutinases, pectinases, mannanases, pectate lyases, keratinases, reductases, oxidases, phenoloxidases, ligninases, pullulanases, tannases, pentosanases, lichenases glucanases, arabinosidases, hyaluronidase, chondroitinase, amylases, and mixtures thereof.

The invention is further summarized in the following paragraphs:
1. Use of a cutinase for preventing build-up and/or removal of fuzz and pills from a textile or for improving the whiteness of a textile by exposing the textile to the enzyme during a laundry process.
2. Use according to paragraph 1, wherein the textile is exposed to the cutinase during a wash cycle in a laundry process.
3. Use according to any of paragraphs 1-2, wherein the textile is exposed to the cutinase during a rinse cycle in a laundry process.
4. Use according to any of the preceding paragraphs, wherein the laundry process is carried out in a residential laundry process, an industrial laundry process or in an institutional laundry process.
5. Use according to any of the preceding paragraphs, wherein the laundry process is carried out at least 5 times.
6. Use according to the preceding paragraphs, wherein the laundry process is carried out at least 10 times, at least 15 times or at least 20 times.
7. Use according to any of the preceding paragraphs, wherein the textile comprises polyester.
8. Use according to paragraph 6, wherein the textile further comprises cotton.
9. Use according to paragraph 7, wherein the textile consist of polyester.
10. Use according to any of the preceding paragraphs, wherein the cutinase has at least 70%, 75%, 85%, 90%, 95%, 96%, 97%, 98%, 99% or 100% identity to the amino acid sequence of SEQ ID NO: 1
11. Use according to paragraph 10, wherein the cutinase is a variant SEQ ID NO: 1, which variant comprises substitution of at least one amino acid residue corresponding to position A4, T29, A88, N91, A130, Q139, A161, T166, I169, L167, I178, R181, G182 or R189 of the amino acid sequence of SEQ ID NO: 1.
12. Use according to paragraph 10, wherein the variant has the following alterations T29M+A161L+T166I+L167P+R181P+G182* of the amino acid sequence of SEQ ID NO: 1.
13. Use according to any of the preceding paragraphs, wherein the textile is further exposed to a cellulase during the laundry process.
14. Use according to paragraph 13, wherein the cellulase has at least 70%, 75%, 85%, 90%, 95%, 96%, 97%, 98%, 99% or 100% identity to the amino acid sequence of SEQ ID NO: 2.
15. Use according to paragraph 13, wherein the cellulase has at least 70%, 75%, 85%, 90%, 95%, 96%, 97%, 98%, 99% or 100% identity to the amino acid sequence of SEQ ID NO: 3.
16. A method for laundering a textile comprising the steps of:
   a. Contacting the textile with a wash liquor comprising a surfactant;
   b. Optionally adding one or more detergent components to the wash liquor;
   c. Completing at least one wash cycle; and
   d. Optionally rinsing the textile with water,
      wherein a cutinase should be present in the wash liquor or in the rinse water during at least one wash cycle or at least one rinse cycle.
17. Method according to paragraph 16, wherein the method is carried out at least 5 times, at least 10 times, at least 15 times or at least 20 times.
18. Method according to any of the preceding method paragraphs, wherein the method comprises at least two wash cycles, wherein at least one wash cycle is a pre-wash cycle and at least one wash cycle is a main wash cycle.
19. Method according to any of the preceding method paragraphs, wherein the cutinase is present in the wash liquor during the pre-wash cycle.
20. Method according to any of the preceding method paragraphs, wherein the cutinase is present in wash liquor during the main wash cycle.
21. Method according to any of the preceding method paragraphs, wherein the cutinase is present in the rinse water during the rinse cycle.
22. Method according to any of the preceding method paragraphs, wherein the temperature of the wash liquor is in the range of 15 to 90° C.
23. Method according to paragraph 22, wherein the temperature is in the range of 15° C.-60° C., such as about 15° C., about 20° C., about 25° C., about 30° C., about 35° C., about 40° C., about 45° C., about 50° C., about 55° C. or about 60° C.
24. Method according to paragraph 22, wherein the temperature is in the range of 65° C.-90° C., such as about 65° C., about 70° C., about 75° C., about 80° C., about 85° C. or about 90° C.
25. Method according to paragraph 22, wherein the temperature of the wash liquor is in the range of 40° C.-60° C., such as in the range of 45° C.-60° C. or in the range of 50° C.-60° C.
26. Method according to any of the preceding method paragraphs, wherein the pH of the wash liquor is in the range of 7 to 13.
27. Method according to paragraph 23, wherein the pH of the wash liquor is in the range of 8.5-13, in the range of 9.5-13, in the range of 10-13, in the range of 10.5-13, in the range of 11-13, in the range of 11.5-13, in the range of 12-13 or in the range of 12.5-13.
28. Method according to any of paragraphs 23-24, wherein pH of the wash liquor is adjusted by adding sodium hydroxide, potassium hydroxide, sodium metasilicate sodium carbonate.
29. Method according to any of the preceding method paragraphs, wherein at least 25% of the pills are removed from the surface of the textile surface compared to a similar wash without a cutinase being present in the wash liquor.
30. Method according to paragraph 26, wherein at least 30%, at least 40%, at least 50%, at least 60%, at least 70%, at least 80% or at least 90% of the pills are removed from the surface compared to a similar wash without a cutinase being present in the wash liquor.
31. Method according to any of the preceding method paragraphs, wherein the cutinase has at least 70%, 75%, 85%, 90%, 95%, 96%, 97%, 98%, 99% or 100% identity to the amino acid sequence of SEQ ID NO: 1
32. Method according to paragraph 31, wherein the cutinase is a variant of SEQ ID NO: 1, which variant comprises substitution of at least one amino acid residue corresponding to position A4, T29, A88, N91, A130, Q139, A161, T166, I169, L167, I178, R181, G182 or R189 of the amino acid sequence of SEQ ID NO: 1.
33. Method according to any of paragraph 31-32, wherein the variant has the following alterations T29M+A161L+T166I+L167P+R181P+G182* of the amino acid sequence of SEQ ID NO: 1.
34. Method according to any of the preceding paragraphs, wherein the concentration of the cutinase in the wash liquor is in the range of 0.001-200 mg enzyme protein/L wash liquor.
35. Method according to any of the preceding method paragraphs, wherein the wash liquor further comprise at least one enzyme selected from the group consisting of hemicellulases, peroxidases, proteases, cellulases, xylanases, lipases, phospholipases, esterases, pectinases, mannanases, lyase, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, chlorophyllases, amylases, perhydrolases, peroxidases and xanthanase.
36. Method according to paragraph 35, wherein the further enzyme is a cellulase.
37. Method according to paragraph 36, wherein the cellulase has has at least 70%, 75%, 85%, 90%, 95%, 96%, 97%, 98%, 99% or 100% identity to the amino acid sequence of SEQ ID NO: 2.
38. Use according to paragraph 36, wherein the cellulase has at least 70%, 75%, 85%, 90%, 95%, 96%, 97%, 98%, 99% or 100% identity to the amino acid sequence of SEQ ID NO: 3.
39. Detergent composition comprising a cutinase, a cellulase and a surfactant, wherein the cutinase has at least 70%, 75%, 85%, 90%, 95%, 96%, 97%, 98%, 99% or 100% identity to the amino acid sequence of SEQ ID NO: 1 and wherein the cellulase has at least 70%, 75%, 85%, 90%, 95%, 96%, 97%, 98%, 99% or 100% identity to the amino acid sequence of SEQ ID NO: 2 or the cellulase has at least 70%, 75%, 85%, 90%, 95%, 96%, 97%, 98%, 99% or 100% identity to the amino acid sequence of SEQ ID NO: 3.
40. Composition according to paragraph 39, wherein the surfactant is a nonionic surfactant selected from the group consisting of: alcohol ethoxylates (AE or AEO), alcohol propoxylates, propoxylated fatty alcohols (PFA), alkoxylated fatty acid alkyl esters (ethoxylated and/or propoxylated fatty acid alkyl esters), alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA).

### EXAMPLES

Assays

Assay I

BETEB-Agar Plate for Evaluation of the Cutinase Activity

BETEB was hydrolyzed by cutinase into more soluble agents. Thus, after hydrolysis by enzyme, there were transparent zones on the plates poured with the mixture of Agar and BETEB.

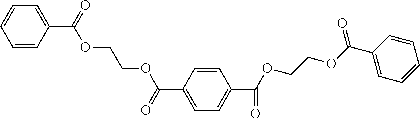 [SMILES: O=C(OCCOC(=O)c1ccc(C(=O)OCCOC(=O)c2ccccc2)cc1)c1ccccc1]

BETEB Molecule Structure

Hydrolysis of BETEB will Produce

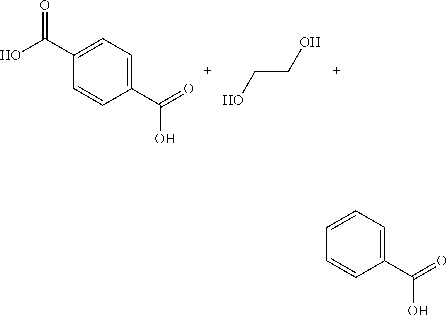

Cutinase activity was measured by the below process:

a) BETEB solution preparation: 5 ml 100% ethanol was added into a glass bottle with a plug, 20 mg BETEB was added into the ethanol and then the bottle was placed in a 60° C. water bath to dissolve the BETEB.

b) 1.5% agar solution was prepared by adding 0.75 g agar into 45 ml Tris-HCl buffer (25 mM, pH 7.0), and then placing the baker in a Microwave oven heating twice for 30 seconds to dissolve the Agar.

c) The agar solution was cooled down to 60° C. and mixed with the BETEB solution prepared in step a. The mixture was poured into a petri dish.

d) Small holes were dug in the petri dish with a tip of 6 mm diameter or puncher.

e) Enzyme sample of 30 microgram/ml was added into the petri dish by a tip with 75 microliter (μl) enzyme sample for each hole. The petri dish was placed at 37° C. overnight.

Cutinase variant showed transparent zones in the area around the holes, as BETEB was hydrolyzed by the cutinase.

Enzymes

In the examples the following enzymes are used:
Cutinase: The cutinase of SEQ ID NO: 1, and
Cutinase variant: variant of cutinase of SEQ ID NO: 1 from Humicola Insolens, with alterations T29M+A161L+T166I+L167P+R181P+G182* on the parent H. insolens cutinase of SEQ ID NO: 1 (the cutinase variant can be produced according to the method described in WO 2001/092502)

### Example 1

Evaluation of Anti-Pilling Wash Performance by Using Test Swatches in Miele Softtronic

This trial was conducted to evaluate the anti-pilling wash performance of a cutinase in a detergent composition composition.

TABLE 1
Detergent Composition

| Detergent | Percent |
|---|---|
| LAS | 7.20% |
| AEOS | 4.20% |
| AEO | 6.50% |
| Soaps | 5.50% |
| Others | |
| Total | 100% |

TABLE 2
Enzymes

| | Weight, mg EP/g detergent, |
|---|---|
| Enzymes | 53 g/load detergent |
| Cutinase variant (1.7 g) | 0.76 |
| Cutninase of SEQ ID NO: 1 | 0.76 |
| (3.4 g) | |

** EP = enzyme protein

Pre-washed polyester textile (to get rid of possible starch, PVA) was washed in same program; under each pH, one with cutinase/cutinase variant, one without cutinase/cutinase variant. The six test conditions were listed in table 3 below. Each condition was washed 20 times, and during the continued wash period, two of each textile were taken out once every five repeats of washing were finished.

TABLE 3
Description of the four different washing conditions used

| | | | Normal | | | Normal |
|---|---|---|---|---|---|---|
| | | Normal | program | | Normal | program |
| | | program | with | | program | with |
| | Normal | with | Cutinase | Normal | with | Cutinase |
| | program | Cutinase | of SEQ ID | program | Cutinase | of SEQ ID |
| Parameters | (blank) | variant | NO: 1 | (blank) | variant | NO: 1 |
| pH | 8 | | | 10 | | |
| Total washing time | 1 hr 46 min | | | | | |
| (main wash) | | | | | | |
| Mainwash - time, | 53 min, 53° C. (60° C. as set-point) | | | | | |
| Peak temperature | | | | | | |
| Rinse time, 3 rinse | 10 min*3 | | | | | |
| Detergent | [12.5 g/kg dry textile] | | | | | |
| composition | | | | | | |
| components as | | | | | | |
| specified in table 1 | | | | | | |
| dH | 7 | | | | | |
| (Ca2+/Mg2+/HCO3− = | | | | | | |
| 4:1:7.5) | | | | | | |
| enzyme | — | 0.76 mg | 0.76 mg | — | 0.76 mg | 0.76 mg |
| | | EP/g | EP/g | | EP/g | EP/g |
| | | detergent | detergent | | detergent | detergent |

Eight of each of the 3 test swatches used (Table 4) was attached to 4 tea towels, on each tea towel, there were 2 pcs of each swatches and total 6 pcs of swatches on each tea towel. Miele washer machine (Softtronic W5841) was loaded with Ballast (Cotton 80% T-shirt, 20% bed sheets), and four tea towels with tested white swatches were added. The total fillings in the wash drum was 4 kg. For the normal program the machine was started and run as normal—this was done 20 times in total. For the enzymatic program the enzyme was added as a wash ingredient (0.43 g per kg dry textile) directly into wash drum, whereupon the machine was started—this was also done 20 times in total.

TABLE 4
Swatches used for anti-pilling evaluation

| Swatch | Number of pcs |
|---|---|
| Woven polyester (100%) (WFK | 8 |
| 30A) | |
| Knit short fiber polyester (100%) | 8 |
| Woven short fiber polyester | 8 |
| (100%) | |

After washing, the tea towels were line dried and continue to next round of repeated wash. After 5 repeats were finished, 1 tea towel was taken out from each condition; the other 3 tea towels were continued to be added to following wash; after 10 repeats were finished, 1 more tea towel was taken out; the other 2 tea towels were continued to be added to following wash; after 15 repeats were finished, 1 more tea towel was taken out; the last tea towel was continued to be added to following wash; after 20 repeats were finished, dried swatches were torn down from the tea towels and panel evaluation on the anti-pilling effect were conducted with a panel of trained test persons, see table 5.

The results clearly show that enzymatic solution was able to keep the surface of the textile as new by cleaving off fuzz and pills formed by wear, tear and wash during wash and preventing new pill formation. Woven polyester (100%) (WFK 30A) and Woven short fiber polyester (100%) showed better anti-pilling performs than Knit short fiber polyester (100%).

TABLE 5
Scores from panel evaluation on anti-pilling effect*

| | | pH 8 | | | pH 10 | | |
|---|---|---|---|---|---|---|---|
| | | | | 2.5 ppm | | | 2.5 ppm |
| | | Normal | 2.5 ppm | Cutinase | Normal | 2.5 ppm | Cutinase |
| | | program | Cutinase | SEQ ID | program | Cutinase | SEQ ID |
| Parameters | Repeats | (Blank) | variant | NO: 1 | (Blank) | variant | NO: 1 |
| Woven | 5 R | 0 | 9 | 7 | 9 | 8 | −1 |
| polyester | 10 R | 0 | 6 | 2 | 8 | 7 | 1 |
| (100%) | 15 R | 0 | 11 | 3 | 5 | 9 | 3 |
| (WFK 30A) | 20 R | 0 | 15 | 8 | 5 | 16 | 4 |
| Knit short | 5 R | 0 | 2 | 1 | 5 | 5 | 1 |
| fiber | 10 R | 0 | −1 | 3 | 1 | 7 | 3 |
| polyester | 15 R | 0 | 2 | 4 | 1 | 6 | 3 |
| (100%) | 20 R | 0 | 11 | 6 | 2 | 11 | 4 |
| Woven | 5 R | 0 | 4 | 4 | 5 | 6 | 0 |
| short fiber | 10 R | 0 | 3 | 2 | 3 | 6 | 0 |
| polyester | 15 R | 0 | 14 | 4 | 7 | 15 | 4 |
| (100%) | 20 R | 0 | 15 | 8 | 12 | 10 | 5 |

*6 trained test persons, 3 votes each per textile can be given by each person. The votes should be given by using blank@pH 8 as a reference based on pill number and pill size. The 1^{st} three columns were scored parallel; and the score in last column was using blank@pH 10 as a reference.
Score 0: same as reference
Score 1: Slightly better
Score 2: Moderate better
Score 3: Significantly better
Score −1: Slightly worse
Score −2: Moderate worse
Score −3: Significantly worse

Measurement of Anti-Pilling Wash Performance

The WFK 30A swatches were also measured to support the results obtained using the panel scoring test. The number of pills were measured using a Digieye from VeriVide Limited (Leicester, LE19 4SG United Kingdom). The results can be seen in table 6 below.

TABLE 6
Measured pills on the WFK 30A swatches*

| | | pH 8 | | pH 10 | |
|---|---|---|---|---|---|
| | | | 2.5 ppm | | 2.5 ppm |
| | | | Cutinase | | Cutinase |
| Parameters | Repeats | Blank | variant | Blank | variant |
| Woven polyester | 5 R | 49 | 31 | 11 | 25 |
| (100%) (WFK | 10 R | 41 | 41 | 51 | 15 |
| 30A) | 15 R | 49 | 55 | 54 | 17 |
| | 20 R | 71 | 26 | 77 | 14 |

*Digieye, VeriVide Limited (Leicester, LE19 4SG United Kingdom)

At both pH's it is clear to see that when no cutinase is added the number of pills increase washes upon washes, ending at 71-77 pills. However, using the same wash process but including a cutinase limits the formation of pills. This is seen the best at pH 10 where the number of pills stay as low as 14-25 pills washes upon washes.

### Example 2

Evaluation of Rejuvenation Wash Performance by Using Test Swatches in Miele Softtronic

This trial was conducted to evaluate rejuvenation effect of a Cutinase.

Detergent Composition Components:

All detergent composition components used are the detergent defined in table 1 in example 1.

TABLE 7
Enzyme

| | Weight, mg EP/g detergent, |
|---|---|
| Enzymes | 53 g/load detergent |
| Cutinase variant (1.7 g) | 0.76 |
| Cutinase of SEQ ID NO: 1 | 0.76 |
| (3.4 g) | |

** EP = enzyme protein

Pre-washed and abraded polyester textile (to get rid of possible starch, PVA) was washed in same program under two pHs. Under each pH, one condition with cutinase/cutinase variant, one condition without dutinase/cutinase variant. The four test conditions were listed in table 3 above. Each condition was washed 20 times, and during the continued wash period, two of each textiles were taken out once every five repeats were finished.

Eight of each of the 3 test swatches used (same number and kind of swatches as used in example 1, Table 4, but the swatches were abraded by Nu Martindale (series no. 403/97/2050) at 2000 spin one by one (Nu Martindale was Manufactured by James H Heal&Co, LTD, UK.)) was attached to 4 tea towels, one each tea towel, there were 2 pcs of each swatches and total 6 pcs of swatches on each tea towel. Mielemachine (Softtronic W5841) was loaded with Ballast (Cotton 80% T-shirt, 20% bed sheets), and four tea towels with tested white swatches were added. The total fillings in the wash drum is 4 kg. For the normal program the machine was started and run as normal—this was done 20 times in total. For the enzymatic program the enzyme was added as a wash ingredient (0.43 g per kg dry textile) directly into wash drum, whereupon the machine was started—this was also done 20 times in total.

After washing, the tea towels were line dried and continue to next round of repeated wash. After 5 repeats were finished, 1 tea towel was taken out from each condition; the other 3 tea towels were continued to be added to following wash; after 10 repeats were finished, 1 more tea towel was taken out; the other 2 tea towels were continued to be added to following wash; after 15 repeats were finished, 1 more tea towel was taken out; the last tea towel was continued to be added to following wash; after 20 repeats were finished, dried swatches were torn down from the tea towels and panel evaluation on the anti-pilling effect were conducted with a panel of trained test persons, see table 9.

The results clearly show that enzymatic solution was able to rejuvenate textile by removal of fuzz and pills formed over time in both pH 8 and pH 10. Woven polyester (100%) (WFK 30A) and Woven short fiber polyester (100%) showed better rejuvenation than Knit short fiber polyester (100%).

TABLE 9
Scores from panel evaluation on removal of fuzz and pills (rejuvenation)*

| | | pH 8 | | | pH 10 | | |
|---|---|---|---|---|---|---|---|
| | | | | 2.5 ppm | | | 2.5 ppm |
| | | Normal | 2.5 ppm | Cutinase | Normal | 2.5 ppm | Cutinase |
| | | program | Cutinase | SEQ ID | program | Cutinase | SEQ ID |
| Parameters | Repeats | (Blank) | variant | NO: 1 | (Blank) | variant | NO: 1 |
| Woven | 5 R | 0 | 5 | 9 | 13 | 3 | 4 |
| polyester | 10 R | 0 | 6 | 6 | 6 | 8 | −4 |
| (100%) | 15 R | 0 | 6 | 7 | 8 | 6 | −1 |
| (WFK 30A) | 20 R | 0 | 11 | 5 | 7 | 4 | 0 |
| Knit short | 5 R | 0 | 6 | 7 | 6 | 8 | 6 |
| fiber | 10 R | 0 | 3 | 2 | 5 | 5 | 0 |
| polyester | 15 R | 0 | 7 | 4 | 3 | 11 | 4 |
| (100%) | 20 R | 0 | 8 | 8 | 8 | 6 | −2 |
| Woven | 5 R | 0 | 7 | 6 | 9 | −1 | −7 |
| short fiber | 10 R | 0 | 3 | −3 | 7 | 5 | −2 |
| polyester | 15 R | 0 | 12 | 0 | 2 | 15 | 7 |
| (100%) | 20 R | 0 | 16 | 6 | 11 | 10 | 2 |

*6 trained test persons, 3 votes each per textile can be given by each person. The votes should be given by using blank@pH 8 as a reference based on pill number and pill size. The 1^{st} three columns were scored parallel; and the score in last column was using blank@pH 10 as a reference.
Score 0: same as reference
Score 1: Slightly better
Score 2: Moderate better
Score 3: Significantly better
Score −1: Slightly worse
Score −2: Moderate worse
Score −3: Significantly worse

### Example 3

Evaluation of Color Brightness Due to Reduced Pilling Using Cutinase Variant in a Washing Trial with Colored Swatches in Miele Softtronic

In a new washing trial identical to the pH=10 trial described in Example 1, the Cutinase variant was used to study influence of reduced pilling on colored swatches with respect to color brightness/color clarity.

In the trial different colored swatches knitted as well as woven and also velour swatches were included. In addition the non-colored WFK 30A was included as control for anti-pilling. The used swatches are listed in table 10 below.

| | | | Anti-pilling and |
|---|---|---|---|
| | | PET, | color brightness |
| Swatch | Vendor | 100% | Effect |
| Red knitted PET | internal | Yes | Yes |
| Striped Velour blue/white | Uni Qlo | Yes | No |
| Striped Velour pink/white | Uni Qlo | Yes | No |
| Striped Velour blue/black | Uni Qlo | Yes | No |
| Jersey grey | Uni Qlo | Yes | Yes |
| T shirt grey knitted | Decathlon | Yes | Yes |
| Black woven | Decathlon | Yes | Yes |
| Black, thick knitted | Decathlon | Yes | Yes |
| WFK 30A, woven | CFT | Yes | Yes |

Results for the non-colored WFK 30A swatch were similar to described in Example 1, i.e. clear anti-pilling effect when washed with the Cutinase variant vs. the wash done without the Cutinase variant. A similar anti-pilling effect was seen on all the coloured swatches except for the velour type. For the velour type no difference could be seen when washing with/without the Cutinase variant. In addition to the anti-pilling effect observed on the colored swatches the swatches with reduced pilling appeared to have much brighter colors, especially visible on the red swatch and the black woven swatch. As a consequence colored polyester textiles washed with the Cutinase variant will appear brighter and look new for longer, both with respect to pills and color.

1-5. (canceled)

6. A method for laundering a textile, comprising the steps of:
a. contacting the textile with a wash liquor comprising a surfactant;
b. optionally adding one or more detergent components to the wash liquor;
c. completing at least one wash cycle; and
d. optionally rinsing the textile with water,
wherein a cutinase is present in the wash liquor or in the rinse water during at least one wash cycle or at least one rinse cycle.

7. The method according to claim 6, wherein the method is carried out at least 5 times.

8. The method according to claim 6, wherein the method comprises at least two wash cycles, wherein at least one wash cycle is a pre-wash cycle and at least one wash cycle is a main wash cycle.

9. The method according to claim 8, wherein the cutinase is present in the wash liquor during the pre-wash cycle.

10. The method according to claim 8, wherein the cutinase is present in the wash liquor during the main wash cycle.

11. The method according to claim 6, wherein the cutinase is present in the rinse water during the rinse cycle.

12. The method according to claim 6, wherein temperature of the wash liquor is in the range of 15 to 90° C.

13. The method according to claim 6, wherein pH of the wash liquor is in the range of 7 to 13.

14. The method according to claim 6, wherein the wash liquor further comprises at least one enzyme selected from the group consisting of hemicellulases, peroxidases, proteases, cellulases, xylanases, lipases, phospholipases, esterases, pectinases, mannanases, lyase, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, chlorophyllases, amylases, perhydrolases, peroxidases and xanthanase.

15. A detergent composition, comprising a cutinase, a cellulase and a surfactant, wherein the cutinase has at least 70% sequence identity to the amino acid sequence of SEQ ID NO: 1 and wherein the cellulase has at least 70% sequence identity to the amino acid sequence of SEQ ID NO: 2 or the cellulase has at least 70% sequence identity to the amino acid sequence of SEQ ID NO: 3.


SEQUENCE LISTING (3 sequences)

SEQ ID NO: 1 - protein, 194 aa, Humicola insolens
QLGAIQNDLESGSPDACPDAILIFARGSTEPGNMGITVGPALANGLKEHIPNIWIQGVGGPYDAALATNFLPRGTSQANIDEGKRLFHLAHQKCPNTPVVAGGYSQGAALIAAAVSELSGAVKEQVKGVVLFGYTQNLQNRGGIPNYPRERTKVFCNVGDAVCTGTLIITPAHLSYTIQARGEAARFLVDRIRA

SEQ ID NO: 2 - protein, 305 aa, Humicola insolens
MRSSPLLRSAVVAALPVLALAADGRSTRYWDCCKPSCGWAKKAPVNQPVFSCNANFQRITDFDAKSGCEPGGVAYSCADQTPWAVNDDFALGFAATSIAGSNEAGWCCACYELTFTSGPVAGKKMVVQSTSTGGDLGSNHFDLNIPGGGVGIFDGCTPQFGGLPGQRYGGISSRNECDRFPDALKPGCYWRFDWFKNADNPSFSFRQVQCPAELVARTGCRRNDDGNFPAVQIPSSSTSSPVNQPTSTSTTSTSTTSSPPVQPTTPSGCTAERWAQCGGNGWSGCTTCVAGSTCTKINDWYHQCL

SEQ ID NO: 3 - protein, 435 aa, Humicola insolens
MARGTALLGLTALLLGLVNGQKPGETKEVHPQLTTFRCTKRGGCKPATNFIVLDSLSHPIHRAEGLGPGGCGDWGNPPPKDVCPDVESCAKNCIMEGIPDYSQYGVTTNGTSLRLQHILPDGRVPSPRVYLLDKTKRRYEMLHLTGFEFTFDVDATKLPCGMNSALYLSEMHPTGAKSKYNPGGAYYGTGYCDAQCFVTPFINGLGNIEGKGSCCNEMDIWEANSRASHVAPHTCNKKGLYLCEGEECAFEGVCDKNGCGWNNYRVNVTDYYGRGEEFKVNTLKPFTVVTQFLANRRGKLEKIHRFYVQDGKVIESFYTNKEGVPYTNMIDDEFCEATGSRKYMELGATQGMGEALTRGMVLAMSIWWDQGGNMEWLDHGEAGPCAKGEGAPSNIVQVEPFPEVTYTNLRWGEIGSTYQEVQKPKPKPGHGPRSD